(19) United States
(12) Patent Application Publication
(10) Pub. No.: US 2015/0082842 A1
(43) Pub. Date: Mar. 26, 2015

(54) MOBILE DETACHER AND HARD TAG

(71) Applicant: Checkpoint Systems, Inc., Thorofare, NJ (US)

(72) Inventors: Lawrence Appalucci, Villanova, PA (US); Anthony Piccoli, West Deptford, NJ (US)

(21) Appl. No.: 14/492,956

(22) Filed: Sep. 22, 2014

Related U.S. Application Data
(60) Provisional application No. 61/882,157, filed on Sep. 25, 2013.

(51) Int. Cl. E05B 73/00; G06K 19/077

(52) U.S. Cl. CPC E05B 73/0064; G06K 19/07737; E05B 73/0017
USPC 70/19

(57) ABSTRACT

This disclosure generally relates to the field of security tags, and more particularly, to a system, device, and method for removing a hard tag by utilizing a mobile detacher. A detacher key is inserted into the security device and rotated to release a pin, securing the merchandise to the device, from the device. The detacher key or device may include a cam of which is rotated to apply sufficient force on a retaining clip to release the pin from the clip to remove the pin out of the tag.

### CROSS REFERENCE TO RELATED APPLICATION

This application claims priority to U.S. Provisional Application 61/882,157, filed on Sep. 25, 2013, and titled “MOBILE DETACHER FOR HARD TAG,” the content of which is incorporated herein by reference in its entirety.

### BACKGROUND

The present disclosure relates to a security hard tag device, system, and method to unlock the hard tag. A detacher key or hard tag may include a cam for applying force to a pin retaining clip in the hard tag to release the pin from the hard tag.

Many retail items have security tags attached to them as a security measure to prevent their unauthorized removal from a desired area. One such security tag is a hard tag, wherein some hard tags use a pin as a way to attach the tag to merchandise. A means to secure the pin inside the hard tag is necessary for the tag to function as intended. It is also necessary to remove the pin once an article has been authorized for removal from the area, such as when bought before removing the item from the store.

Many hard tag detachers use a rare earth magnet as a means to remove the pin from the tag. The cost of quality rare earth magnet materials has escalated in recent years and is resulting in both an increase in selling price and erosion of profit margins for manufacturers selling these magnetic detachers. These magnetic detachers are typically of considerable weight and they are not easily transportable around a store. Customers who wish to purchase a product with a hard tag attached must bring the item to the checkout area where the hard tag can be detached by such a magnetic detacher. With the magnetic detacher located permanently at a checkout station, a concentration of customers forms in the checkout area, creating a log jam effect forcing customers to wait in line to have the tags removed from the merchandise. Customers who do not wish to stay and wait may choose to forgo the purchase and simply leave the store without the item, resulting in lost sales for the retailer.

The present disclosure eliminates the need for permanently fixed magnetic detachers, including expensive rare earth magnets, by providing a mechanical method of unlocking the pin from the hard tag anywhere in the store. The disclosure reduces the weight of the detacher to the point that it can easily be carried around the store by a sales associate, either in a pocket, attached to a belt, or in any other method of casual transportation. This detacher mobility further allows a retailer to take advantage of mobile checkout, a major trend in retail stores that enhances the customer experience by eliminating long checkout lines at the main point-of-sale and thus makes more efficient use of retail labor within the store. A reduction in checkout lines, including for tag detachment, is a win-win situation for both the retailer and the customer.

### SUMMARY

Embodiments of this disclosure provide a security device, system, and method to remove a pin from the device using a mobile detacher key. The mobile detacher key is inserted into the device and rotated to unlock the pin from the clutches of a pin retaining clip inside the device.

Embodiments of this disclosure are directed to a security device. The security device includes a pin. The security device also includes a housing. The housing includes a housing recess located about the housing and configured to receive the pin. The housing also includes a housing cavity located within the housing. The housing also includes a housing cavity entrance located about the surface of the housing for access to the housing cavity. The security device includes a retaining clip located within the housing and configured to secure the pin within the housing when the pin is received through the recess. The security device also includes a detacher key configured to enter the housing through the housing cavity entrance and into the housing cavity and to turn to rotate the pin from the retaining clip.

According to one embodiment, the retaining clip includes two pin restraint members configured to secure the pin when the pin is positioned in the housing recess and between the restraint members. The restraint members are configured to open to release the pin when a sufficient force is applied to a section of the retaining clip when the detacher key is rotated.

According to one embodiment, the retaining clip includes a clip body. The retaining clip also includes a secured end connected to one side of the clip body and extending transverse to the clip body in the same plane. The secured end includes an orifice located in a front portion of the secured end proximal to a front edge of the retaining clip. A pivot anchor extends through the orifice. The pivot anchor is a member of the housing. The retaining clip also includes an unsecured end connected to the opposing side of the clip body from the secured end. The unsecured end extends in the same direction from the clip body as the secured end. The unsecured end includes an exposed edge being the section of the retaining clip where the sufficient force is applied. The retaining clip also includes a resistance arm connected to the secured end at a back portion of the secured end distal from the front edge of the retaining clip and extending orthogonally downward from the plane of the secured end and clip body, and extending parallel in the plane of the clip body on the opposing side of the clip body from location of the pin restraint members. A first pin restraint member is connected to the secured end and a second pin restraint member is connected to the unsecured end. The restraint members are located in proximity to each other and face each other. The pin is located between the restraint members to secure the pin between the restraint members.

According to one aspect of one embodiment, the retaining clip is configured to rotate about the pivot anchor. The resistance arm is located in a trough about the housing. The restraint members are configured to release the pin when a sufficient torsional torque is applied on the retaining clip when the sufficient force is applied to the exposed edge such that the pin retaining clip rotates about the pivot anchor and the resistance arm remains secure in the trough providing a resultant torque force in a direction opposite the rotation direction of the retaining clip. The exposed edge is located on a side of the unsecured end opposite the side of the unsecured end nearer to the resistance arm.

According to one embodiment, the security device also includes a cam configured to apply the sufficient force to the section of the retaining clip when the detacher key is turned.

According to one embodiment, the cam is located on an end of the detacher key first entering the housing. The pin retaining clip and the key rotate about parallel planes.

According to another embodiment, the cam is located on an end of the detacher key first entering the housing. The pin retaining clip and the key rotate about orthogonal planes.

According to one embodiment, the cam is located in the housing cavity and is configured to receive the detacher key and rotate in the same direction as the detacher key when the detacher key is turned. The retaining clip and the cam are configured to rotate about parallel planes.

According to another embodiment, the cam is located in the housing cavity and is configured to receive the detacher key and rotate in the same direction as the detacher key when the detacher key is turned. The retaining clip and the cam are configured to rotate about orthogonal planes.

According to one embodiment, the housing cavity entrance to the housing cavity is located on a side of the housing different from another side of the housing where the housing recess is located. The housing also includes a key path shield configured to at least partially encase a segment of the housing cavity in the housing. The housing cavity includes a slot configured to allow for the cam to rotate within the slot and external of the key path shield to allow for the cam to apply the sufficient force to the section of the retaining clip when the detacher key is rotated.

According to one aspect of one embodiment, the housing also includes a post located in the housing cavity to block unauthorized devices, other than the detacher key from releasing the pin from the retaining clip.

According to one embodiment, the cam is located in the housing cavity. The cam includes a dome-shaped top. The cam also includes a cam extension protruding from a side of the cam. When the detacher key rotates, the cam extension is configured to apply the sufficient force to the section of the retaining clip. The cam also includes a bottom surface including an opening. The opening is configured to receive a first end of the detacher key. The design of the first end of the detacher key aligns with the design of the opening so that the detacher key connects with the opening.

According to one embodiment, the housing includes an excess receiving volume to allow for the cam to tilt from side to side in the excess receiving volume. When the cam is tilted beyond a particular threshold the cam arm will misalign with the section of the retaining clip so that the cam arm may not apply the sufficient force on the section of the retaining clip.

According to one embodiment, the housing also includes a flexible spacer connected to the cam. The flexible spacer is configured to retain the cam in a first position so that the cam arm is prevented from applying a force to the section of the retaining clip. The flexible spacer is configured to depress to a second position when the detacher key is pushed against the cam to permit the cam arm to apply the sufficient force to the section of the retaining clip.

According to one embodiment, the housing also includes a stabilizer including two walls. Each wall extends from the housing and is parallel from the other wall. The two walls are configured to provide guidance for the cam to rotate between the two walls so that the cam may align with the section of the retaining clip such that the cam may apply sufficient force to the section of the retaining clip when the detacher key is turned.

According to one embodiment, the housing also includes a flange in the housing cavity located between the detacher key and the retaining clip. The flange is configured to require an additional torque force to rotate the detacher key to apply the sufficient force to the section of the retaining clip.

According to one embodiment, the detacher key includes a gripping pad located on a second end of the detacher key opposite a first end of the detacher key first entering the housing. The detacher key also includes a shaft extending from the gripping pad to the first end of the detacher key, the gripping pad providing a moment arm about the axis of the shaft to generate a torque force to turn the detacher key to release the pin from the retaining clip.

According to one aspect of one embodiment, the detacher key also includes a shoulder protruding outwards from the shaft, whereby the shoulder is positioned at a known distance from the first end of the detacher key such that when the first end of the detacher key enters the housing, the housing prevents the detacher key from entering the housing any further beyond the shoulder such that the detacher key is located at a position for the detacher key to turn so that the sufficient force is applied to the section of the retaining clip.

According to one embodiment, the detacher key is non-magnetic.

According to another embodiment, the detacher key is 50 mm or less in length.

According to one embodiment, a security element is located within the housing. The security element includes at least one of an EAS element or a RFID element.

Embodiments of this disclosure are also directed to a method for removing a security device from an article. The method includes providing an article with a security device housing and a pin attached about the article and into the security device housing. The pin is secured in a retaining clip located in the security device housing. And the article is secured between the pin and the security device housing. The method also includes inserting a detacher key into the housing. The method also includes rotating the detacher key. The rotation of the detacher key provides sufficient force on the retaining clip to release the pin from the retaining clip. The method also includes removing the pin from the retaining clip and from the housing.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of this disclosure are best understood from the following detailed description when read in connection with the accompanying drawings. For the purpose of illustrating this disclosure, there is shown in the drawings embodiments that are presently preferred, it being understood, however, that this disclosure is not limited to the specific instrumentalities disclosed. Included in the drawings are the following Figures:

FIG. 1 illustrates a hard tag with a detacher key inserted into the tag according to one embodiment;

FIG. 2 illustrates the hard tag of FIG. 1 with the detacher key and pin removed;

FIG. 3 illustrates a cross-sectional view of the hard tag of FIG. 1 according to one embodiment;

FIG. 4A illustrates an enlarged top-side view of the retaining clip and a perspective view of the detacher key with an attached cam according to one embodiment;

FIG. 4B illustrates a side view of the pin retaining clip and detacher key of FIG. 4A;

FIG. 4C illustrates a front view of the retaining clip and detacher key;

FIG. 5 illustrates a hard tag with the housing cavity entrance located on the side of the tag according to one embodiment;

FIG. 6 illustrates a cross-sectional perspective view of the hard tag of FIG. 5;

FIG. 7 illustrates an enlarged top-side view of the retaining clip and detacher key inside the side entry hard tag of FIG. 5;

FIG. 8A illustrates a side view of hard tag with side entry showing the housing cavity entrance and a post located inside the housing cavity according to one embodiment;

FIG. 8B illustrates a cross-sectional top-side view of the side entry tag of FIG. 8A with the detacher key, retaining clip, key path shield, and several housing supports removed to show post in housing cavity;

FIG. 9 illustrates a cross-sectional view of a hard tag with a cam inside the tag according to one embodiment;

FIG. 10 illustrates a cross-sectional side view of a hard tag with a cam located inside the hard tag according to one embodiment;

FIG. 11A illustrates an enlarged view of the cam shown in FIG. 10 tilted one direction;

FIG. 11B illustrates an enlarged view of the cam shown in FIG. 10 tilted another direction;

FIG. 12 illustrates a cam in a hard tag with a spacer according to one embodiment;

FIG. 13 illustrates a variety of detacher key end designs according to one embodiment; and

FIG. 14 illustrates a flange in the hard tag according to one embodiment.

### DETAILED DESCRIPTION OF ILLUSTRATIVE EMBODIMENTS

This document describes a device and method to detach a security hard tag from merchandise using a detacher key. The detacher key may be a mobile key so that detachment of the security hard tag merchandise may occur in any location in or about the store by a retail employee.

In the disclosure, the term “security device” may be designated as security hard tag. “Security hard tag” may alternatively be designated “hard tag” or simply “tag.” In the disclosure, the detacher device to remove the security device from the merchandise may also be designated as “detacher key,” “detacher,” or “key.”

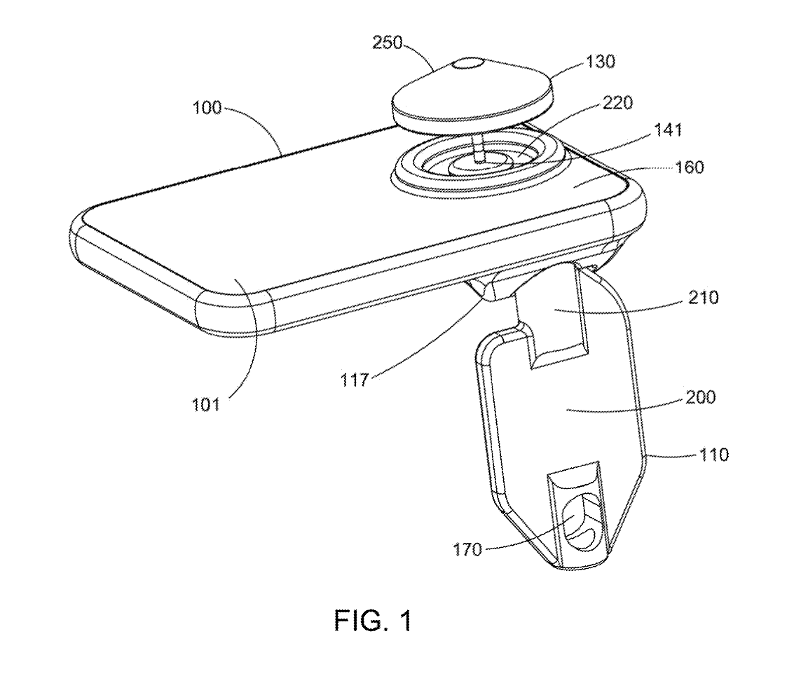

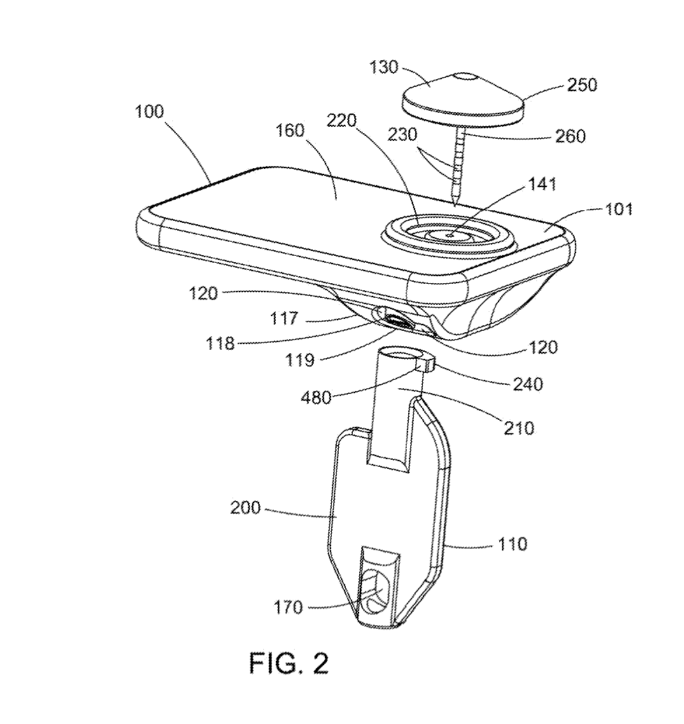

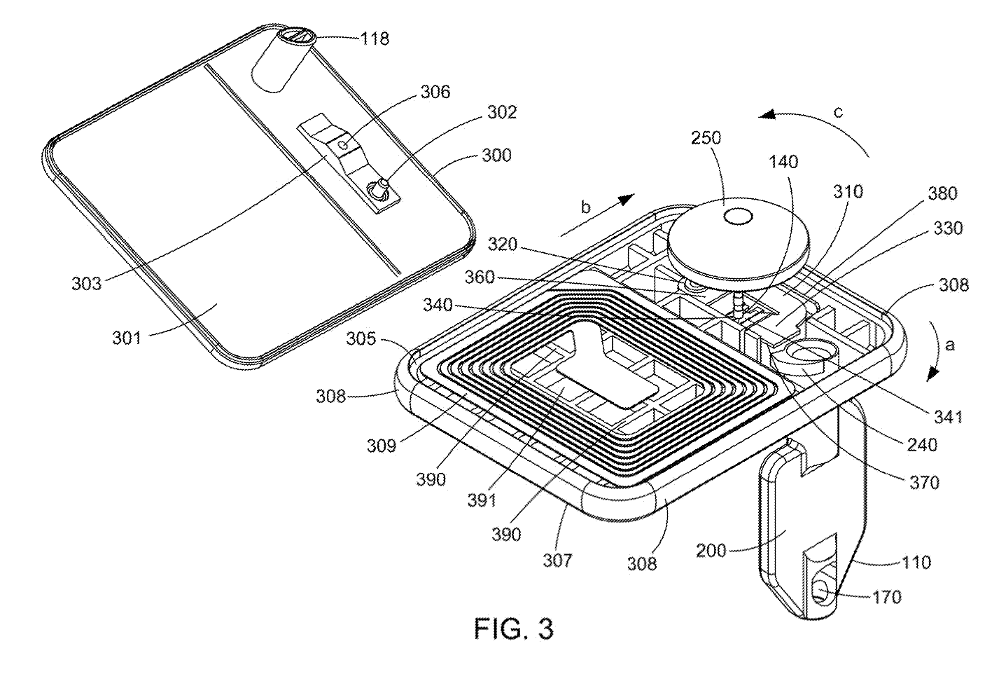

FIG. 1 illustrates a security hard tag 100 with a detacher key 110 inserted into the tag 100 for detaching pin 130 according to one embodiment. The hard tag 100 is partially formed by an exterior shell, or housing 101, which may be a hard or rigid material, such as plastic. The housing 101 may be strong enough to thwart an individual from an unauthorized attempt to use their hands or other tools to break open the housing 101 and thus remove the tag 100 from the merchandise. The hard tag 100 includes face 160 on the housing 101, which is a side of the housing 101 on which is located recess opening 141, to receive pin 130. On the opposite side of the housing 101 from face 160 is located tag mound 117 that includes a housing cavity entrance 119 (see FIG. 2), an opening in the mound 117 to the housing cavity 120 (see FIG. 2). In FIG. 1, the detacher key 110 is shown inserted through the housing cavity entrance 119 and into the housing cavity 120. When inserted into the hard tag 100, the detacher key 110 may be used to allow for the pin 130 to be removed from recess opening 141 and out of hard tag 100. In the preferred embodiment, the housing cavity 120 is located proximal to the recess opening 141, though an opposite side of the housing 101, to ensure that the detacher key 110 is properly aligned in proximity internal to the tag 100 with retaining clip 310 (see FIG. 3). The pin 130 is used to secure merchandise to the tag 100. The pin 130 can be pushed through merchandise material, or through any other material connected to the merchandise, before being inserted into recess 140 in hard tag 100 (see FIG. 3).

When the detacher key 110 is not in use it may be removed from the tag 100. The key 110 may be lightweight and small enough that it may then be stored in a store employee's pocket, or secured to a key ring (not shown) which may pass through key cavity 170 located about one end of detacher key 110. The detacher key 110 shown in FIG. 1 is 50 mm in length, but may be larger or smaller in size. The detacher key 110 may be small and lightweight so as to allow a user to carry it in their pocket, on a belt, or other method of transportation on the person. The detacher key may be non-magnetic. The detacher key may be made of plastic.

FIG. 2 illustrates the hard tag 100 of FIG. 1 with the detacher key 110 and pin 130 removed. The detacher key 110 may have a key paddle 200 which is a wide piece having flat surfaces that allows a user to grip the paddle 200 with fingers to generate a torque force when rotating the key 110 in either direction about key shaft 210. The detacher key 110 may also include a key cam 240 attached at an end of the key shaft 210. As shown in FIG. 2, the key cam 240 is located at the end of the detacher key 110 which first enters the housing cavity 120 and opposite the end of the key 110 where the key cavity 170 is located about key 110. The key cam 240 may be molded as part of the key 110, such as an extension from shaft 210, or it may be manufactured separately and then attached to the key shaft 210 using methods such as, but not limited to, adhesive. The key shaft 210 may be solid or hollow. The key shaft 210 shown in FIG. 2 is hollow so that guide post 118, which is cylinder in shape, in housing cavity 120, fits into the hollow shaft 210 as key shaft 210 is inserted into the housing cavity 120. When a user turns the detacher key 110, the key cam 240 is rotated wherein it contacts a section of retaining clip 310 (see FIG. 3) located in housing 101, and wherein a sufficient force is applied to a particular section of the pin retaining clip 310, so that the retaining clip 310 releases pin 130. The pin retaining clip 310 may also be referred to as “retaining clip” or “clip,” as it is the instrument to secure the pin 130 in tag 100. The housing cavity entrance 119 and housing cavity 120 may be shaped to accommodate the key 110 and key cam 240. As shown in FIG. 2 in one embodiment, the key 110 must be turned/rotated to a certain position to allow the key cam 240 to enter the housing cavity entrance 119 and housing cavity 120. The shape of the housing cavity entrance 119 and housing cavity 120 may be modified to accommodate any size or shape detacher key and may not be limited by the size of shape of the embodiments shown.

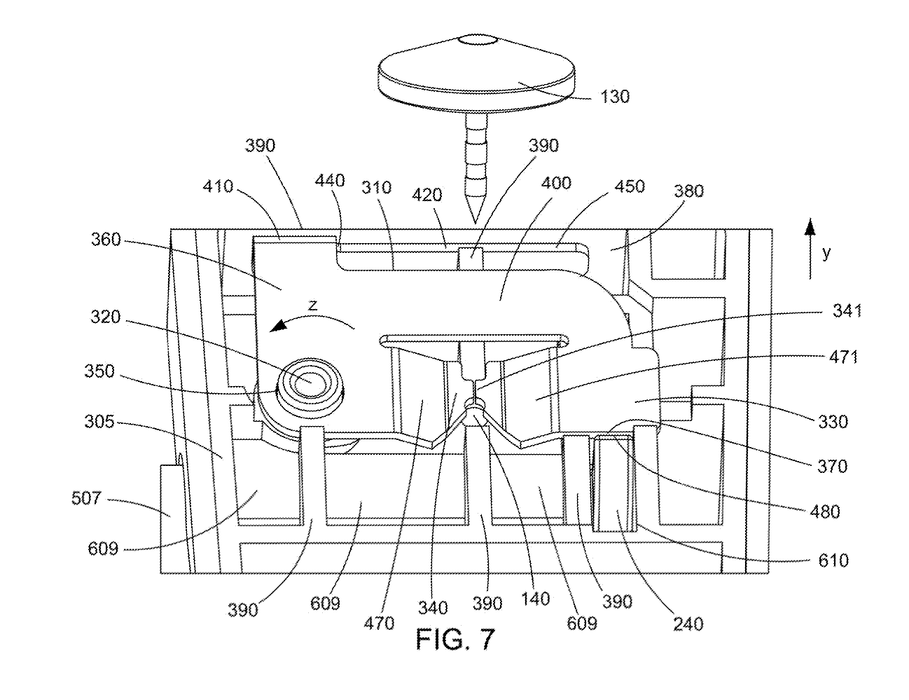

Pin 130 is shown removed from recess opening 141 in FIG. 2. Pin 130 includes a pinhead 250 located at one end of pin shaft 260 opposite the end first inserted into recess opening 141. The width of the pinhead 250 may ensure that merchandise remain secured between the pinhead 250 and housing 101. In other embodiments, the housing 101 may include an enclosure 220, surrounded by an extension above face 160 around recess opening 141 that may allow for pinhead 250 to fit within the extension surrounding the enclosure 220. This may allow pin 130 to be shielded by the tag housing 101 thereby making it difficult to pry pin head 250, using a screwdriver or similar device, from between the pinhead 250 and the tag 100. Pin shaft 260 may include ridge(s) 230 allowing for the pin 130 to be better secured by the retaining clip 310 (see also FIG. 7) with ridge 230. The ridge 230 may be wide enough to allow the restraint members 340 of retaining clip 310 to fit within a ridge 230 to secure the pin 130. Pin shaft 260 may have more than one ridge 230 at different locations along the shaft 210 to allow for merchandise of differing thicknesses to be secured by the same pin 130 between the tag 100 and pinhead 250. The recess 140 may accommodate a pin with various ridges 230 located along the shaft 260 and the adjustable pin depth allows the retailer to purchase one standard pin that can be used for many different products.

FIG. 3 illustrates a cross-sectional view of the hard tag 100 of FIG. 1, according to one embodiment. FIG. 3 shows a view of the internal arrangement of hard tag 100 of FIG. 1 and FIG. 2. The tag housing 101 is shown separated as tag cover 300 and tag body 307. The tag body 307 includes outer housing walls 308 and internal housing supports 390 extending between walls 308. The supports 390 may form an area to accommodate location of the retaining clip 310 and/or a security element 309. The security element 309, or a portion of the security element 309, may be an electronic article surveillance (EAS) element or a radio frequency identification (RFID) element. The supports 390 may also be positioned to create troughs 391 in the tag body 307. The security element 309 may be located in any one or more troughs 391. The tag body 307 may have an outer ledge 305 incorporated into outer walls 308 where the tag cover 300 may be pressed into the tag body 307 to form the housing 101.

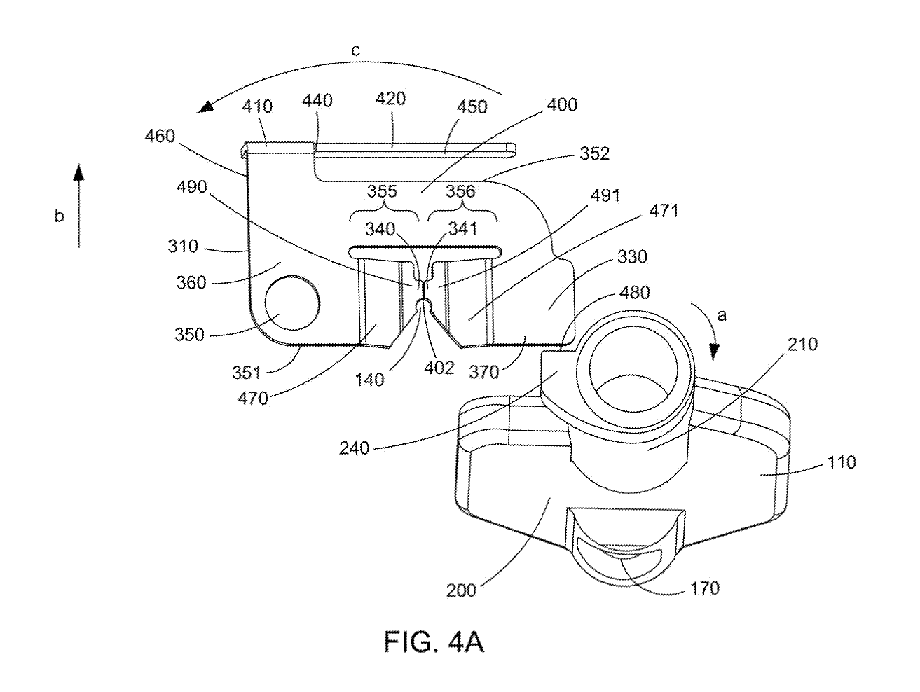

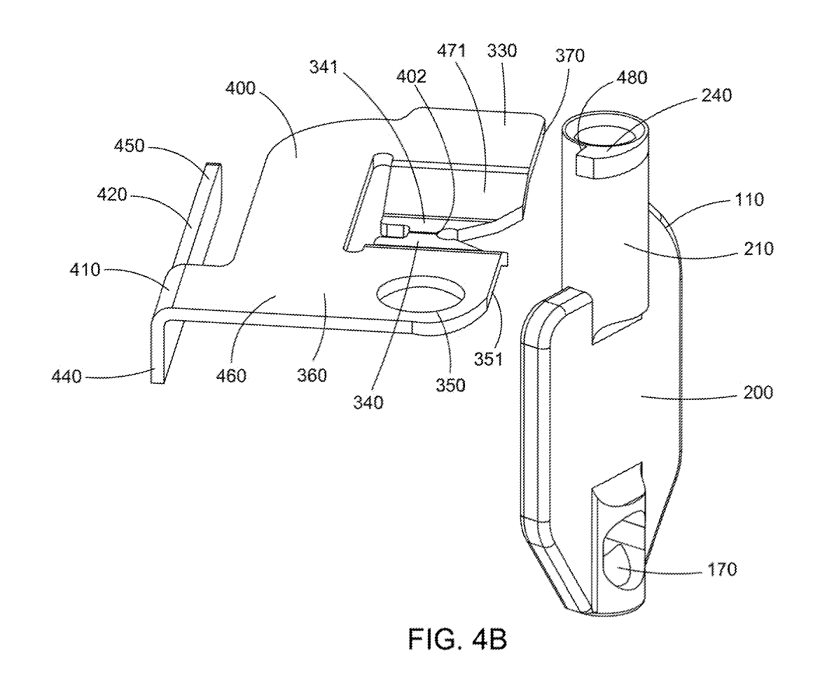

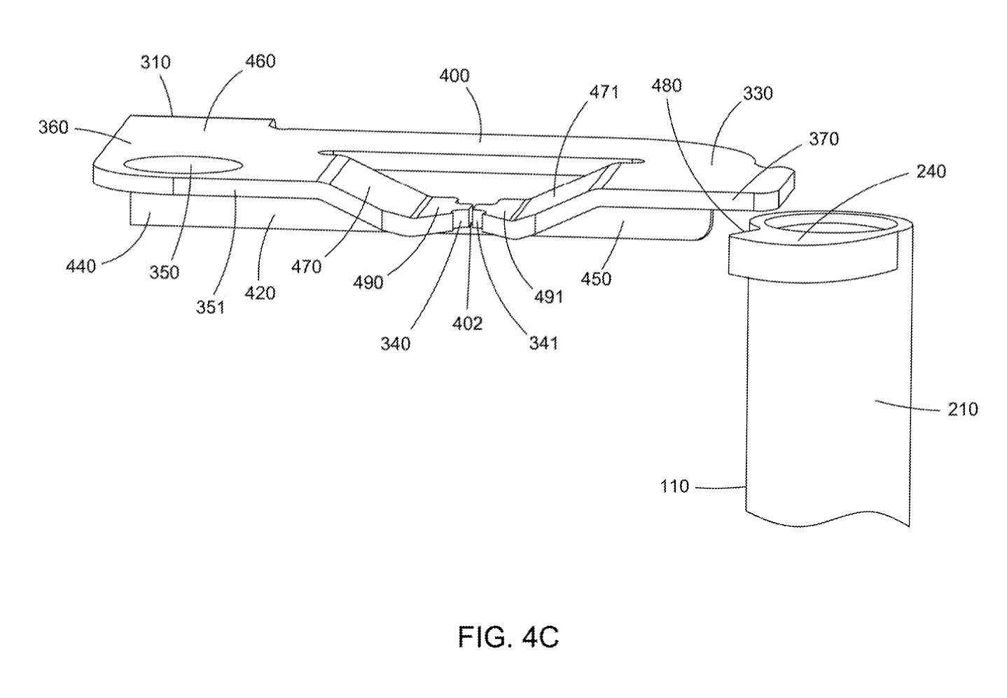

Recess 140 is located for alignment between the restraint members 340, 341 of retaining clip 310 (see also FIG. 4A for enlarged view). The pin retaining clip 310 is preferably made of thin metal and is secured on one end by clip pivot anchor 320, which is preferably a molded part of tag body 307. Pivot anchor 320 may keep the retaining clip 310 properly aligned while the tag 100 is attached to merchandise and may also prevent the retaining clip 310 from moving while the pin 130 is locked or unlocked in tag 100. The retaining clip 310 may include orifice 350 on the secured end 360 of the retaining clip 310 that fits around clip pivot anchor 320 (see also FIG. 4A). As shown in FIG. 4A, the orifice 350 is located in a proximal portion of the secured end 360 proximal to the front edge 351 of the retaining clip 310. Unsecured end 330 of retaining clip 310 may move freely in two dimensions when a force is applied to it, particularly at an exposed edge 370 located on unsecured end 330. The force may be applied by key cam 240 in the preferred embodiment. Housing cavity 120 (see FIG. 2) allows for the key cam 240 to be positioned within the housing cavity 120 to contact a particular section of retaining clip 310 to provide sufficient force to that section so that the retaining clip 310 releases pin 130. As shown in FIG. 3, the key cam 240 may contact the exposed edge 370 of the unsecured end 330 of retaining clip 310 after the detacher key 110 is inserted into the housing cavity entrance 119 and through housing cavity 120 and then rotated (see also FIG. 1). The key cam 240 rotates such that the flat key cam edge 480 of cam 240 contacts the exposed edge 370 and increases the torsional force applied to exposed edge 370 as the key 110 is rotated applying increased force to the exposed edge 370. Retaining clip trough 380 located in housing 101 provides a section in the tag body 307 where part of the retaining clip 310 is secured.

In FIG. 3, internal cover bottom face 301 of tag cover 300 is shown. A pin guide 303 protrudes generally perpendicularly from the bottom face 301. The pin guide 303 functions to ensure that the pin 130 is properly aligned when the pin 130 is inserted into the recess opening 141 from the opposing side of tag cover 300, and passes through pin guide channel 306 of pin guide 303 to recess 140 between restraint members 340. The pin guide 303 may be molded as part of tag cover 300 and is firm enough that it may not distort if pin 130 is inserted slightly misaligned. The pin guide 303 can extend from the cover bottom face 301 at a distance such that the bottom of pin guide opposite pin guide 303 connection with internal cover bottom face 301, stops just before contacting retaining clip 310. In other embodiments, two pin guides may exist to guide pin 130 on opposite sides of the retaining clip 310, or no guides may exist.

In one embodiment, the tag cover bottom face 301 may also have a pivot anchor receiver 302 extending from face 301. The pivot anchor receiver 302 may be aligned with pivot anchor 320 located on tag body 307 so as to secure the circumference of the pivot anchor 320 within the circumference of the pivot anchor receiver 302. The pivot anchor receiver 302 may further secure the pin retaining clip 310 and ensure that the pin guide 303 is properly aligned with the retaining clip 310 when the tag cover 301 and tag body 307 are connected and sealed. As shown the pivot anchor receiver 302 may be inserted within the circumference of the pivot anchor 320 in a recess at the top of the pivot anchor 320. The tag cover 301 and tag body 307 may be secured by welding or adhesive.

FIG. 4A illustrates an enlarged top-side view of retaining clip 310 and perspective view of detacher key 110, with an attached cam 240, according to one embodiment. FIG. 4B illustrates a side view of the pin retaining clip 310 and detacher key 110 of FIG. 4A. FIG. 4C illustrates a front view of the retaining clip 310 and detacher key 110. Retaining clip 310 is shown to include orifice 350 that may surround pivot anchor 320 extending from tag body 307. Orifice 350 is located on the portion of secured end 360 proximal to the front edge 351 of the retaining clip 310. Its location ensures that the retaining clip 310 rotates about pivot anchor 320 when a force is applied to the non-secured end 330 at exposed edge 370. Secured end 360 is connected to a clip body 400 which links the secured end 360 and unsecured end 330. The clip body 400 may be sufficiently rigid so as not to become distorted, bent, or cracked when the retaining clip 310 is rotated. The unsecured end 330 is connected to the clip body 400 opposite the secured end 360. The exposed edge 370, on the unsecured end 330, is shown as the edge located closest to the cam 240. The unsecured end 330 is free to rotate when a force is applied to the exposed edge 370 of the unsecured end 330.

Both the secured end 360 and unsecured end 330 each include clip segments 355, 356 extending toward one another and generally parallel with clip body 400. Each segment 355, 356 includes a restraint member 340, 341. Restraint segues 470, 471 may interconnect their respective restraint members 340, 341 to their respective end 330, 360, as shown in FIG. 4A. A security restraint piece 490, 491 may be connected between their respective restraint members 340, 341 and restraint segues 470, 471 and may also be positioned on different planes than either the members 340, 341 or segues 470, 471 as shown in FIG. 4C.

The location of the secured end 360 and unsecured end 330 on a different plane than either the security restraint pieces 490, 491, restraint members 340, 341, or restraint segues 470, 471 may provide additional stability when the tag cover 300 is placed on tag body 307 and the pin 130 is secured. Pin guide 303 (see FIG. 3) may extend from the tag cover 300 and occupy the depression lower than the plane of tag body 400, secured end 360, and unsecured end 330 as created by the restraint segues 470, 471. The pin guide 303 is preferably located directly above and between security restraint pieces 490, 491. The restraint members 340, 341 may have a cut out 402 directly above recess 140 where the pin 130 will be held by the restraint members 340, 341. The restraint members 340, 341 may be of a thickness that will allow for them to fit within a pin ridge 230 to secure pin 130 tightly between members 340, 341.

The secured end 360 may also be connected to a resistance arm 420 via clip transition piece 410 at a portion of the secured end 360 distal from orifice 350 and the front edge 351 and proximal to back edge 352. The clip transition piece 410 extends perpendicularly down from the clip top surface 460, as shown in FIG. 4B. The clip transition piece 410 is solid and formed as part of retaining clip 310. The clip transition piece 410 is connected to one end of resistance arm 420, identified as resistance arm fixed end 440. The opposite end of the resistance arm 420 is arm free end 450. When the retaining clip 310 is placed inside the tag body 307 the resistance arm 420 is positioned in retaining clip trough 380. The resistance arm 420 is tightly confined in the clip trough 380 so that if the resistance arm 420 experiences any movement it almost immediately contacts the tag body 307 and is prevented from moving further.

Referring to FIG. 3 and FIG. 4A, when tag 100 is removed from an article the user, e.g. store employee, will insert key 110 into tag 100. The user will grip the key 110 about key paddle 200 and rotate the key 110 about the axis of the key shaft 210 in the rotation direction as shown in FIG. 3. This causes the key cam 240 to rotate applying force about the surface area of the cam edge 480 with the exposed edge 370 of the unsecured end 330 of retaining clip 310. Key cam 240 continues to rotate causing an increase in exerted force in direction ‘b’ on the unsecured end 330. The retaining clip 310 is fixed about secured end 360 by the pivot anchor 320 so that the retaining clip 310 may rotate about pivot anchor 320 in direction ‘c,’ in the opposing direction of rotation of key cam 240 in generally the same plane. As the retaining clip 310 is experiencing this rotation, the resistance arm free end 450 is unable to move since confined in retaining clip trough 380. Therefore the immovable free end 450 generates a torsional force through the clip transition piece 410 and into the clip body 400 opposing the rotation of the pin retaining clip 310 in direction ‘c.’ This opposing force holds the retaining clip 310 in place. A user is able to turn the key 110 to exert sufficient torsional force to temporarily weaken the grip of the restraint members 340, 341 on pin 130 since the torsional force forces the restraint members 340, 341 to open, removing restraint members' 340, 341 contact with pin ridges 230. Once the pin ridges 230 are not in contact with restraint members 340, 341 the pin 130 may be pulled from between the restraint members 340, 341 and out from recess 140 to remove from tag 100. The key 110 may then be rotated back to its original position in direction opposite of ‘a,’ so that the restraint members 340, 341 close and the retaining clip 310 is restored to its original form. The tag 100 may then be ready to accept the same pin 130 or another pin for repeated use. When the tag 100 is attached to merchandise, the pin 130 is again inserted into recess 140 and pushed between restraint members 340, 341 until the appropriate pin ridge 230 is positioned between the restraint members 340, 341 thus securing pin 130 into tag 100.

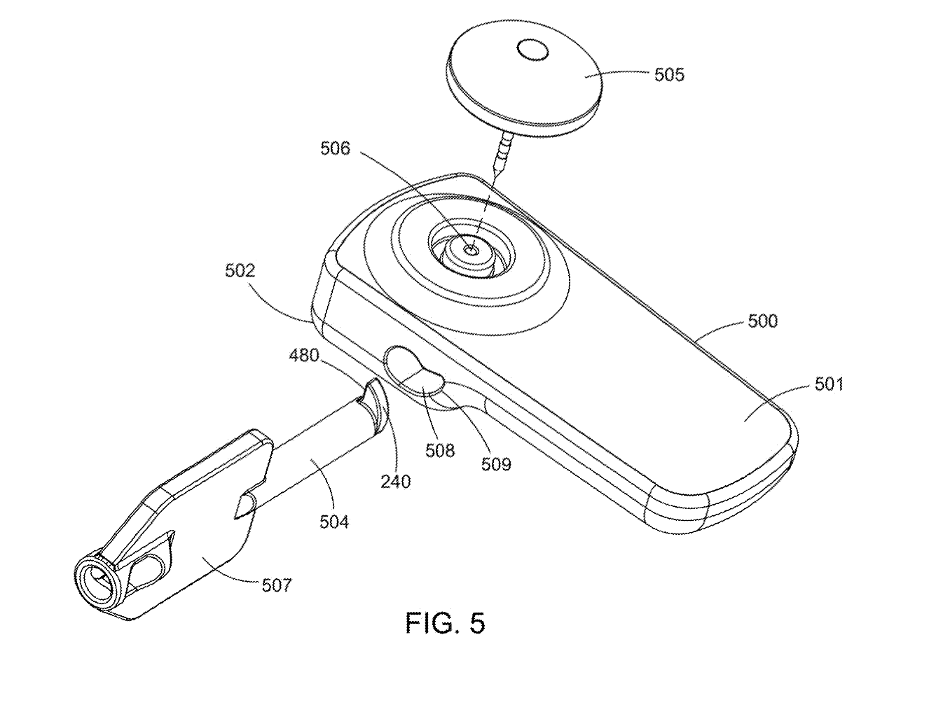

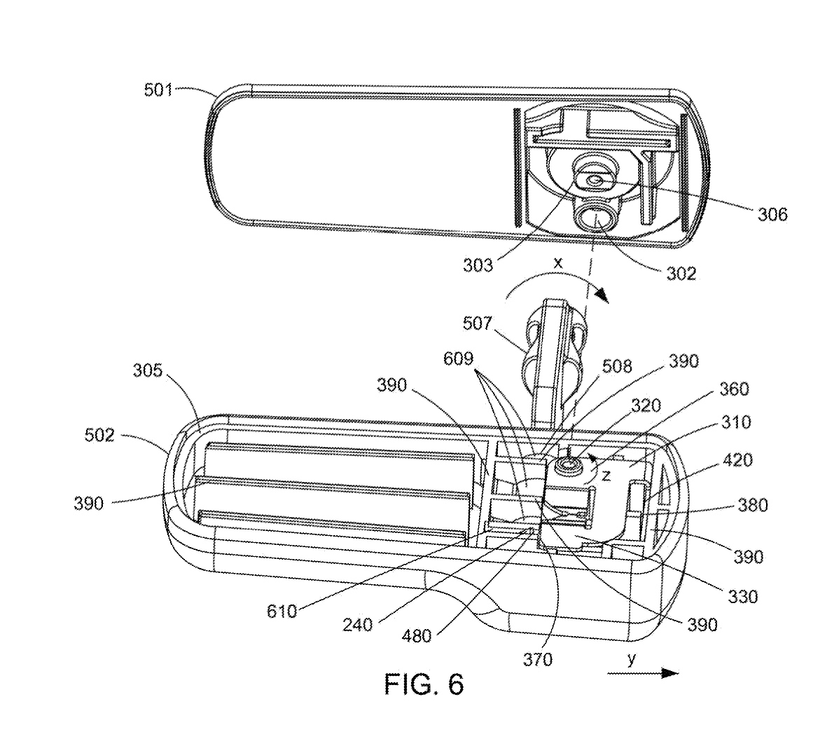

FIG. 5 illustrates a hard tag 500 with the housing cavity entrance 509 located on a side of the tag 500 according to one embodiment. The housing cavity entrance 509 is located on a side orthogonal to a side where recess opening 506 is located. This may increase the difficulty of using an item, other than an authorized key 507 to release pin 505 from tag 500. The side entry tag 500 is composed of a tag cover 501 and a tag body 502. The tag body 502 may be non-uniform shape to accommodate the housing cavity 508 within the key 507, and/or the retaining clip 310 (see FIG. 6). In other embodiments, the tag body 502 may have uniform depth. Detacher key 507 utilized with the side entry tag 500, may differ from key 200 (see FIG. 1) due to an elongated shaft 504. Key 507 may also include cam 240 attached on one end of shaft 504. The elongated shaft 504 may be a solid material, hollow, or any combination thereof. Positioning the housing cavity entrance 509 on the side of tag 500 creates a longer housing cavity 508 in the tag 500 so that key 507 must travel further into the tag 500 before it may be rotated to apply sufficient force on the retaining clip 310, at for example an exposed edge 370 of the retaining clip 310. In the embodiment shown, the housing cavity entrance 509 is on the side of the tag 500 opposite the unsecured end 330 of retaining clip 310.

FIG. 6 illustrates a cross-sectional perspective view of the hard tag 500 of FIG. 5. Housing cavity 508 is shown located in tag body 502 and the cavity 508 may be covered by a key path shield 609. The key path shield 609 is shown as segments of partial cylinders located between internal housing supports 390. The housing supports 390 located within housing cavity 508 have opening to allow the key 507 to pass through and under key path shield 609. The key path shield 609 increases the difficulty of inserting a foreign object to jam tag 500 and break open retaining clip 310 by creating a confined space into which key 507 may be inserted. In other embodiments, the key path shield 609 may extend the length of the housing cavity 508. The key path shield 609 may be segmented or one piece, and the walls of the shield 609 may be partial sides of a cylinder or may be a wall extending the full circumference of a cylinder.

Near the end of the housing cavity 508, where the key path shield 609 does not exist, an open cam slot 610 is located to allow the key cam 240 to rotate and thus contact retaining clip 310. The key cam edge 480 contacts, as for example exposed edge 370, when the key 507 is rotated in direction ‘x.’ The key cam edge 480 applies linear force against exposed edge 370 in direction ‘y.’ Retaining clip 310 may be the same shown and used in other embodiments.

As shown in FIG. 6, the pivot anchor receiver 302 may cover pivot anchor 320, as opposed to being inserted into a portion of pivot anchor 320 shown in FIG. 3.

FIG. 7 illustrates an enlarged view of retaining clip 310 and detacher key 507 inside the side entry hard tag 500 of FIG. 5 and FIG. 6. Key cam 240 is visible through cam slot 610. Key 507 may be rotated along a different axis than the embodiment described in FIG. 3 and FIG. 4. In FIG. 3 and FIG. 4, the key 507 and the pin retaining clip 310 rotate in opposite directions on the same two-dimensional plane. In this embodiment, the axis of key 507 rotates perpendicularly to the axis rotation of the retaining clip 310, when the key 507 rotates in direction ‘x’ and the retaining clip 310 rotates about pivot anchor 320 in direction ‘z.’ However, functionality of the retaining clip 310 remains the same as described in previous figures for securing and releasing pin 130. When key 507 is rotated it causes the key cam 240 to contact the exposed edge 370 of retaining clip 310. Further rotation of key 507 after initial contact may cause retaining clip 310 to rotate about clip pivot anchor 320 in direction ‘z.’ Resistance arm 420 provides a force opposing motion, opposite direction ‘y,’ as secured in retaining clip trough 380 between internal housing supports 390. Increasing the torque as applied by the key 507 turning in direction ‘x,’ causes the retaining clip 310 to further rotate, resulting in the restraint members 340, 341 disengaging from pin ridge 230, and thereby allowing pin 130 to be removed from the tag 500.

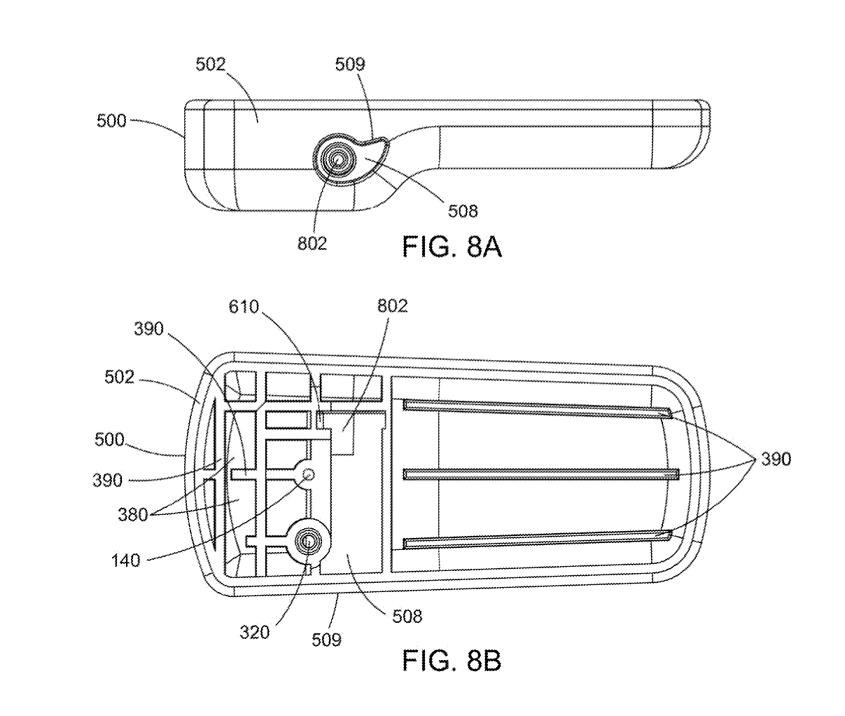

FIG. 8A illustrates a side view of the side entry tag 500 showing the housing cavity entrance 509 and a post 802 located inside the housing cavity 508 according to one embodiment. In this embodiment, post 802 is shown located at the end of housing cavity 508 opposite the cavity entrance 509 wherein the top or free end of the post faces the cavity entrance 509. The diameter of post 802 may be of any diameter smaller than the diameter of the housing cavity 508.

FIG. 8B illustrates a cross-sectional top-side view of the side entry tag 500 of FIG. 8A with the detacher key 507, retaining clip 310, key path shield 609, and several housing supports 390 removed to show post 802 in housing cavity 508. Post 802 may extend from the end of the housing cavity 508, opposite from the housing cavity entrance 509, towards the center of the housing cavity 508. A longer post 802 may be used to increase difficulty to break into tag 500 and manipulate retaining clip 310. Post 802 may extend the length of the housing cavity 508 up to the key entrance 509 or, alternatively, can be any length shorter than that of the housing cavity 508. In some embodiments, placing post 802 at the same end of the housing cavity 508 as the cam slot 610 may increase difficulty to insert a foreign instrument, thin enough to circumvent post 802, and be pliable enough to enter cam slot 610, while simultaneously being rigid enough to apply sufficient force to the retaining clip 310 to release pin 130. Key 507 may have a hollow shaft on the end first is inserted into housing cavity 508. The hollow shaft may allow the key 507 to fit around post 802 when the key 507 is inserted and still allow it to rotate in operation to apply sufficient force to retaining clip 310. In another embodiment, the end of the post 802 opposite the cavity entrance 509 may include a spring such that the key 505 may push back the post 802, compressing the spring against a portion of tag body 502, to a position in which the cam 240 may enter cam slot 610.

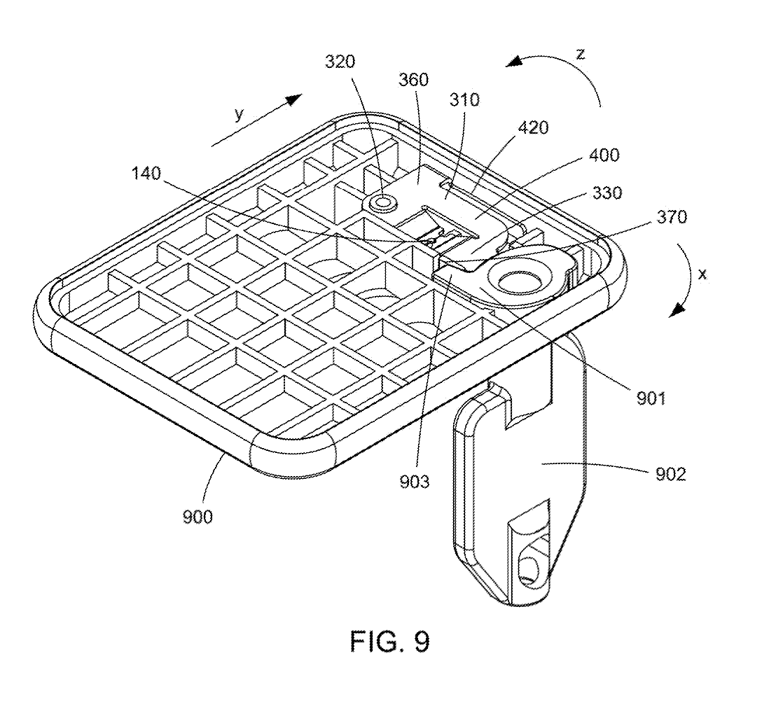

FIG. 9 illustrates a cross-sectional view of hard tag 900 with a cam 901 inside the tag 900 according to one embodiment. In this embodiment, housing cam 901 may be permanently located inside tag 900. Tag 900, with a permanent housing cam 901 inside, may make it nearly impossible for someone using a foreign object or tool to penetrate tag 900 and to contact retaining clip 310 and manipulate it. In some embodiments, the housing cam 901 may be located adjacent to the retaining clip 310. The housing cam 901 may include its own cavity for accepting key 902 on the side of the housing cam 901 facing the housing cavity entrance (not shown). The user can then insert key 902 into the tag 900 where it enters housing cam 901 and may then be rotated. Rotation of key 902 in direction ‘x’ causes the housing cam 901 and housing cam extension 903 to contact the retaining clip 310 at the exposed edge 370. Further rotation of cam 901 causes the retaining clip 310 to function as previously described releasing pin 130.

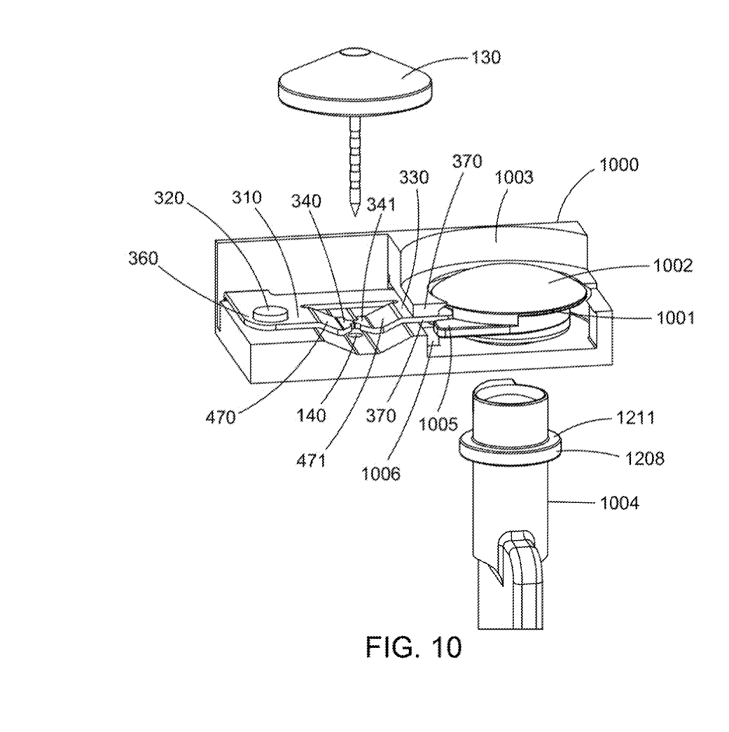

When the cam is located inside the hard tag there is a possibility of someone trying to forcefully rotate the cam with a foreign object or tool (e.g. a screwdriver) to unlock the tag. The foreign object may be inserted into the housing cavity of a tag and firmly pressed to create an indentation in the cam to allow for a tool to rotate the cam and unlock the tag. The threat of someone using this method to remove the tag may be reduced by incorporating other various anti-theft features. One such embodiment is shown in FIG. 10.

FIG. 10 illustrates a cross-sectional side view of a hard tag 100 with another type of cam 1001 located inside the tag 1000 according to one embodiment. Anti-theft cam 1001 may be molded as a single piece of plastic and may have a rounded, dome-shaped top 1002 located on the opposite side of the cam 1001 near the housing cavity (now shown) wherein the key 1004 penetrates. The dome top 1002 may be located in excess receiving volume 1003 inside tag 1000 allowing the anti-theft cam 1001 to tilt from one side to the other.

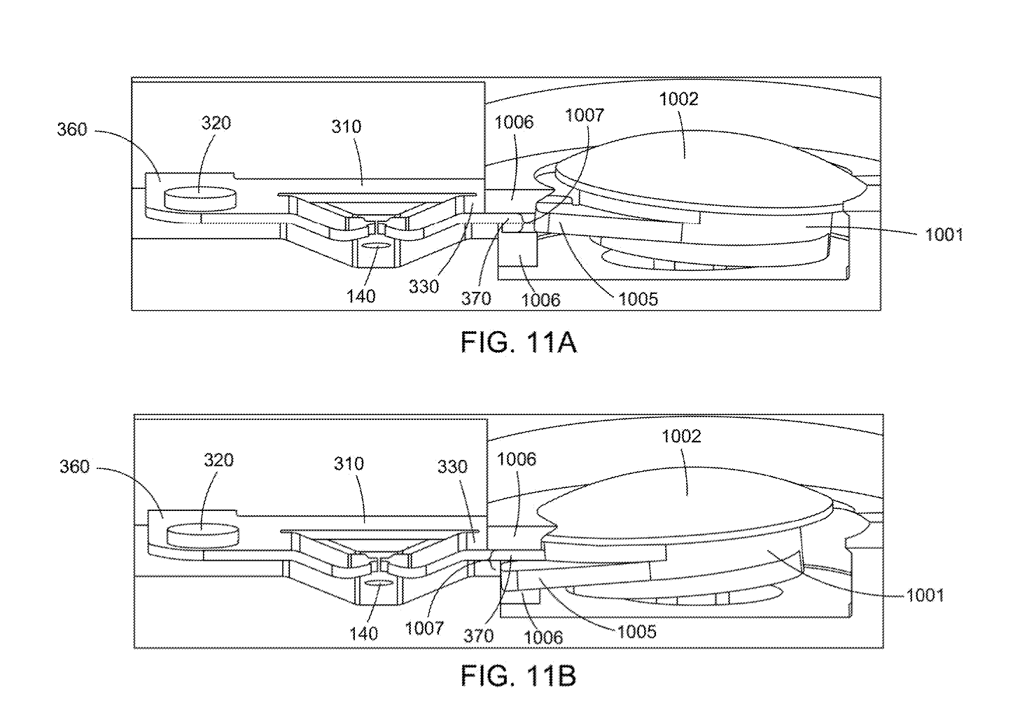

FIG. 11 A and FIG. 11B illustrate enlarged views of the cam 1001 in FIG. 10 tilted in two directions. The anti-theft cam 1001 may tilt in response to an uneven force being applied to the cam 1001. Tilting the cam 1001 may result in cam arm 1005 becoming misaligned above or below gate opening 1007 between gate posts 1006, depending on which side uneven force is applied to the cam 1001. With an even force, the cam arm 1005 should pass gate opening 1007 between gate posts as key 1004 is turned to contact exposed edge 370 of retaining clip 310 to release pin 130. The arm 1005 becoming misaligned with the gate opening 1007 can prevent rotation of the cam 1001. When key 1004 is inserted into the anti-theft cam 1001 a uniform force is applied to it, the cam arm 1005 remains aligned with the gate opening 1007 and the cam 1001 may be rotated allowing cam arm 1005 to pass through gate opening 1007 to apply pressure on the exposed edge 370 of retaining clip 310 to release pin 130.

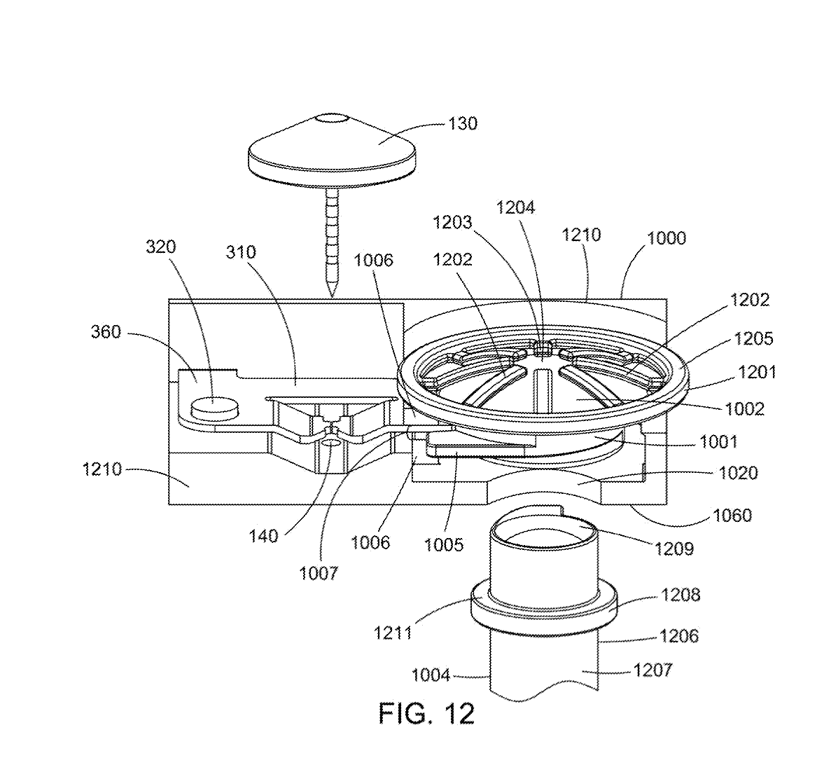

The anti-theft cam 1001 described above may include additional or alternative security features to further reduce the likelihood of unauthorized removal of the hard tag from merchandise. FIG. 12 illustrates cam 1001 in a hard tag 1000 with a spacer 1201 according to one embodiment. In one embodiment, the anti-theft cam 1001 can be combined with a spacer 1201 also shown in FIG. 12. Spacer 1201 may be flexible. Spacer 1201 shown in this embodiment is circular in shape with fingers 1202 extending from the outer rim 1205 toward the spacer center 1204. The spacer fingers 1202 hold the anti-theft cam 1001 in an initial position where the cam arm 1005 is misaligned with the gate opening 1007. The spacer fingers 1202 preferably are made of a material, such as thin metal or plastic, with spring like properties that allow them to flex when a force is applied to the cam and return to the initial position when the force is no longer applied. The ability of the spacer 1201 to flex allows a user to use key 1206 to push cam arm 1005 into a second position to depress the spacer 1201 where cam 1001 may be properly aligned with gate opening 1007. The spacer top 1203, shown about spacer center 1204, may abut a flat surface of the tag housing 1210, creating a ceiling above the anti-theft cam 1001 such that when key 1206 is pushed into tag 1210 and into the bottom of cam 1001, opposite the end of cam 1001 from spacer top 1203, spacer 1201 pushes against the tag housing 1210 and further insertion of key 1206 causes fingers 1202 to flex.

In other embodiments, key 1206 may include a shoulder 1208 protruding outward from the circumference of key shaft 1207 set a known distance from the end of key 1209 first inserted into housing cavity 1020. This distance can be such that cam arm 1005 may be aligned with the gate opening 1007 when key 1206 is inserted into tag 1000 until shoulder face 1211 directly contacts the outside surface of tag 1000. Then, when cam arm 1005 is in correct position it may be rotated to contact the exposed edge 370 of the retaining clip 310, allowing pin 130 to be released as previously described.

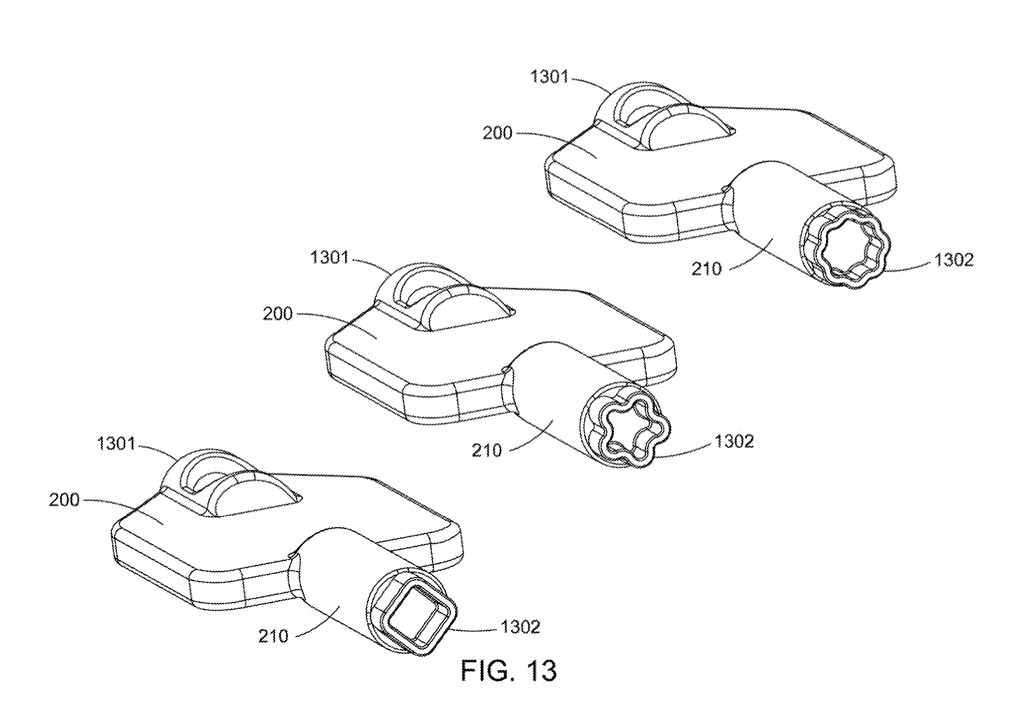

The effectiveness of any hard tag is reduced if a large number of keys exist to open the tag, so that, for example, unauthorized personnel eventually in some manner attain access to such keys. One way to alleviate this problem is to have different designs for the keys such that users with a uniquely designed key can only open certain tags. FIG. 13 illustrates a variety of detacher key end 1302 designs according to one embodiment. Keys 1301 shown may be utilized with any tag including a cam inside the tag. The key insert end 1302 may have any pattern and should not be limited to the designs shown. The design on the key insert end 1302 may have variations in three dimensions. The key insert end 1302 may match the edge of connection opening in the cam. In other embodiments, the key shaft 210 may have the same shape as the key insert end 1302 and thus may match the edge walls of the housing cavity entrance 119 and housing cavity 120 to accommodate insertion of the key 1301 into the tag. In other embodiments, the key insert ends 1302 may contain cams.

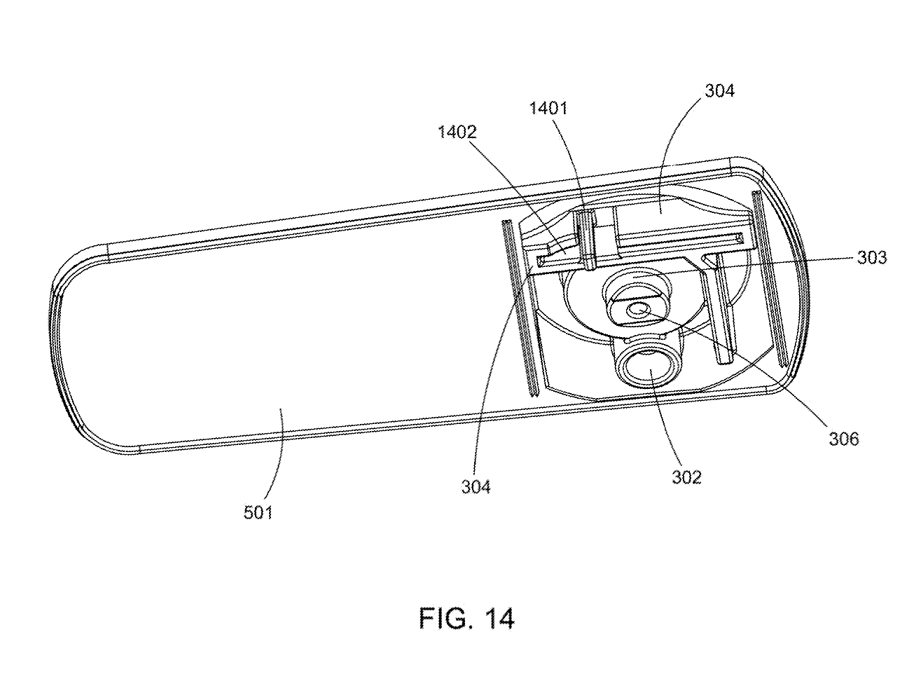

The hard tag of the current invention is designed to hinder someone who is attempting to use an unauthorized device to enter the housing cavity and reach the retaining clip to manipulate the retaining clip and force it to open. One way of increasing the difficulty of achieving this unauthorized attempt is to integrate an additional flange into the tag. FIG. 14 illustrates a flange 1401 in the hard tag 500 according to one embodiment. The tag cover 501 shown is from the side entry tag 500, of FIG. 6, but it should be understood that the additional security feature herein described can be incorporated into any tag. Tag cover channel 304 may include two walls shown as extending from tag cover 501 and parallel to one another. A cutout 1402 may exist in the tag cover channel 304 and partially between the parallel walls to allow cam 509 to rotate inside housing about the top-side of cavity 508 (see also FIG. 6) as between the walls of the tag cover channel 304. The tag cover channel 304 may thus provide guidance for the cam 509 on the key 507 to pass between. Flange 1401, in this embodiment, can be attached to cutout 1402 such that it is positioned between key 507 and the exposed edge 370 of retaining clip 310 when tag cover 501 is in connection with tag body 502. When key 507 is inserted into the tag 500 and rotated, the cam 509 on key 507 contacts the flange 1401. A user must then provide an additional torque force to turn key 507 and force flange 1401 to contact exposed edge 370 of retaining clip 310 to provide the sufficient force to, thereby release pin 130 as previously described. The thickness of the flange 1401 may be changed to require more or less torque force to release pin 130 as desired. For example, a thicker flange would require more force to turn key 507 than a thin flange. The flange 1401 may be a flexible piece of plastic or metal.

It should be understood by those skilled in the art that the above described embodiments are merely illustrative of the present invention. Many other variations are possible without departing from the spirit and scope of the invention. Therefore, the scope of the invention should be determined by the appended claims and their legal equivalents.

Although this disclosure has been described with reference to exemplary embodiments, it is not limited thereto. Those skilled in the art will appreciate that numerous changes and modifications may be made to the preferred embodiments and that such changes and modifications may be made without departing from the true spirit of this disclosure. It is therefore intended that the appended claims be construed to cover all such equivalent variations as fall within the true spirit and scope of this disclosure.

What is claimed is:

1. A system, comprising:
a pin;
a housing, including:
a housing recess located about the housing and configured to receive the pin, and
a housing cavity located within the housing;
a retaining clip located within the housing and configured to secure the pin within the housing when the pin is received through the recess; and
a detacher key configured to enter the housing through the housing cavity and to turn to rotate the pin from the retaining clip.

2. The system of claim 1, wherein the retaining clip comprises:
two pin restraint members configured to secure the pin when the pin is positioned in the housing recess and between the restraint members, and wherein the restraint members are configured to open to release the pin when a sufficient force is applied to a section of the retaining clip when the detacher key is rotated.

3. The system of claim 2, wherein the retaining clip further comprises:
a clip body;
a secured end connected to one side of the clip body and extending transverse to the clip body in the same plane, wherein the secured end comprises an orifice located in a front portion of the secured end proximal to a front edge of the retaining clip; and
an unsecured end connected to the opposing side of the clip body from the secured end, wherein the unsecured end extends in the same direction from the clip body as the secured end, wherein the unsecured end comprises an exposed edge being the section of the retaining clip where the sufficient force is applied.

4. The system of claim 2, wherein a first pin restraint member is connected to the secured end and a second pin restraint member is connected to the unsecured end and wherein the restraint members are located in proximity to each other and face each other and wherein the pin is located between the restraint members to secure the pin between the restraint members.

5. The system of claim 1, further comprising a key cam located on an end of the detacher key, wherein the key cam is configured to apply the sufficient force to the section of the retaining clip when the detacher key is turned.

6. The system of claim 1, further comprising a housing cam located in the housing cavity, wherein the housing cam is configured to receive the detacher key and rotate in the same direction as the detacher key when the detacher key is turned.

7. The system of claim 1, wherein the housing cavity is located on a side of the housing different from another side of the housing where the housing recess is located.

8. The system of claim 1, wherein the housing further comprises a key path shield configured to at least partially encase a segment of the housing cavity in the housing.

9. The system of claim 1, wherein the housing further comprises a post located in the housing cavity to block devices other than the detacher key from releasing the pin from the retaining clip.

10. The system of claim 1, wherein the detacher key comprises:
a gripping pad located on a second end of the detacher key opposite a first end of the detacher key first entering the housing; and
a shaft extending from the gripping pad to the first end of the detacher key, the gripping pad providing a moment arm about the axis of the shaft to generate a torque force to turn the detacher key to release the pin from the retaining clip.

11. The system of claim 1, wherein a security element including an EAS element or a RFID element is located within the housing.

12. A security device, comprising:
a pin;
a housing, including:
a housing recess located about the housing and configured to receive the pin, and
a housing cavity located within the housing; and
a retaining clip located within the housing, wherein the retaining clip is configured to:
secure the pin when the pin is received through the recess, and
release the pin when a force is applied to a section of the retaining clip.

13. The device of claim 12, wherein the retaining clip comprises two pin restraint members configured to secure the pin when the pin is positioned in the housing recess and between the restraint members.

14. The device of claim 12, wherein the retaining clip further comprises:
a clip body;
a secured end connected to one side of the clip body and extending transverse to the clip body in the same plane, wherein the secured end comprises an orifice located in a front portion of the secured end proximal to a front edge of the retaining clip; and
an unsecured end connected to the opposing side of the clip body from the secured end, wherein the unsecured end extends in the same direction from the clip body as the secured end, wherein the unsecured end comprises an exposed edge being the section of the retaining clip where the sufficient force is applied.

15. The device of claim 12, further comprising a housing cam located in the housing cavity, wherein the housing cam is configured to receive a detacher key and rotate in the same direction as the detacher key when the detacher key is turned.

16. The system of claim 1, wherein a security element including an EAS element or a RFID element is located within the housing.

17. A method, comprising:
providing a pin and a housing, wherein the housing includes a housing recess located about the housing, a housing cavity located within the housing, and a security element including at least one of an electronic article surveillance element or a radio frequency identification element;
inserting the pin through the housing recess;
securing the inserted pin with a retaining clip located within the housing;
inserting a detacher key through the housing cavity; and
turning the inserted detacher key to rotate the pin from the retaining clip.

18. The method of claim 17, further comprising:
securing the pin with two pin restraint members when the pin is inserted through the housing recess, wherein the two pin restraint members are configured to open to release the pin when a sufficient force is applied to a section of the retaining clip when the detacher key is rotated.

19. The method of claim 17, further comprising applying, via a key cam located on an end of the detacher key, the sufficient force to the section of the retaining clip when the detacher key is rotated.

20. The method of claim 16, further comprising blocking, via a post located within the housing cavity, unauthorized devices other than the detacher key from releasing the pin from the retaining clip.
